(19) United States
(12) Patent Application Publication
(10) Pub. No.: US 2025/0348566 A1
(43) Pub. Date: Nov. 13, 2025

(54) APPLICATION IDENTITY ACCOUNT COMPROMISE DETECTION

(71) Applicant: Microsoft Technology Licensing, LLC, Redmond, WA (US)

(72) Inventors: Ye XU, Kirkland, WA (US); Etan Micah BASSERI, Seattle, WA (US); Maria PUERTAS CALVO, Seattle, WA (US); Dana Scott KAUFMAN, Redmond, WA (US); Alexander T. WEINERT, Seattle, WA (US); Andrew NUMAINVILLE, Kent, WA (US)

(21) Appl. No.: 19/275,483

(22) Filed: Jul. 21, 2025

Related U.S. Application Data
(63) Continuation of application No. 17/557,274, filed on Dec. 21, 2021, now abandoned.

(51) Int. Cl. G06F 21/31; G06F 21/54; G06F 21/55; H04L 9/40

(52) U.S. Cl. CPC G06F 21/316; G06F 21/54; G06F 21/554; H04L 63/107

(57) ABSTRACT

Some embodiments improve the security of service principals, service accounts, and other application identity accounts by detecting compromise of account credentials. Application identity accounts provide computational services with access to resources, as opposed to human identity accounts which operate on behalf of a particular person. Authentication attempt access data is submitted to a machine learning model which is trained specifically to detect application identity account anomalies. Heuristic rules are applied to the anomaly detection result to reduce false positives, yielding a compromise assessment suitable for access control mechanism usage. Embodiments reflect differences between application identity accounts and human identity accounts, in order to avoid inadvertent service interruptions, improve compromise detection for application identity accounts, and facilitate compromise containment and recovery efforts by focusing on credentials individually. Aspects of familiarity measurement, model feature selection, and a model feature engineering pipeline are also described.

### CROSS REFERENCE TO RELATED PATENT APPLICATIONS

This patent application is a continuation of and claims priority to U.S. patent application Ser. No. 17/557,274, filed on Dec. 21, 2021, entitled “APPLICATION IDENTITY ACCOUNT COMPRISE DETECTION;” and hereby incorporated by reference into this patent application.

### BACKGROUND

Attacks on computing systems take many different forms, including some forms which are difficult to predict, and forms which may vary from one situation to another. Accordingly, one of the guiding principles of cybersecurity is “defense in depth”. In practice, defense in depth is often pursed by forcing attackers to encounter multiple different kinds of security mechanisms at multiple different locations around or within a computing system. No single security mechanism is able to detect every kind of cyberattack, or able to end every detected cyberattack. But sometimes combining and layering a sufficient number and variety of defenses will deter an attacker, or at least limit the scope of harm from an attack.

To implement defense in depth, cybersecurity professionals consider the different kinds of attacks that could be made. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place. Some defenses might not be feasible or cost-effective in a given environment. However, improvements in cybersecurity remain possible, and worth pursuing.

### SUMMARY

Compromise detection tools and techniques suitable for securing the accounts of human users are distinguished herein from tools and techniques which are specifically tailored to detect compromise that impacts an application identity. User accounts in a computing system are generally employed to provide human users with access to digital resources. An application identity account, by contrast, is employed principally or solely to provide a software service with access to digital resources. Some examples of application identities include a service principal, a service account identity, a multi-tenant application identity, or an identity and access management role assigned to a software service.

Some embodiments described herein detect the use of a compromised credential to access an account of an application identity by utilizing an anomaly detection functionality of a trained machine learning model. The model is trained specifically to detect application identity account compromise, as opposed to detecting human user account compromise. Some embodiments also apply one or more heuristic rules to the anomaly detection result to formulate a compromise assessment.

In some embodiments, the compromise assessment is supplied to an access control mechanism, which may respond by alerting administrators or security personnel, recommending or requiring replacement of a compromised credential, or increasing the amount of logging, for example. Unlike the behavior of some systems when they find a human user account is compromised, the present embodiments do not by default block access to a compromised service account or proactively take potentially blocking actions such as requiring multifactor authentication. Blocking access by a service may adversely impact multiple users. Other aspects of application identity account compromise detection functionality are also described herein, including for example specific machine learning features and specific heuristic rules.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter.

Rather, this Summary is provided to introduce-in a simplified form-some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating aspects of a computing system which has one or more of the application identity compromise detection enhancements taught herein;

FIG. 3 is a block diagram illustrating an enhanced system configured with application identity compromise detection functionality;

FIG. 4 is a block diagram illustrating aspects of data features used primarily or solely within or by machine learning models;

FIG. 5 is a block diagram illustrating aspects of data features used primarily or solely in compromise assessment calculations that are performed outside a machine learning model;

FIG. 6 is a block diagram illustrating aspects of illustrating aspects of data features used for compromise assessment calculations or machine learning models or both;

FIG. 7 is a data flow diagram illustrating aspects of a feature engineering pipeline which is further illustrated in FIG. 15;

FIG. 8 is a flowchart illustrating steps in some application identity compromise detection methods;

FIG. 9 is a flowchart further illustrating steps in some application identity compromise detection methods, incorporating FIG. 8;

FIG. 10 is a formula defining a Kullback-Leibler divergence measure;

FIG. 11 is a definition of a modified Kullback-Leibler divergence measure;

FIG. 12 is an example of an adapted non-weighted inverse document frequency calculation;

FIG. 13 is an example of an adapted weighted inverse document frequency calculation involving one login request per day from a first IP address;

FIG. 14 is an example of an adapted weighted inverse document frequency calculation involving five thousand login requests per day from a second IP address; and

FIG. 15 is a data flow diagram illustrating additional aspects of the feature engineering pipeline introduced in FIG. 7.

### DETAILED DESCRIPTION

### Overview

Innovations may expand beyond their origins, but understanding an innovation's origins can help one more fully appreciate the innovation. In the present case, some teachings described herein were motivated by Microsoft innovators who recognized and faced technical challenges arising from their efforts to make Azure® clouds and other computing environments more secure (mark of Microsoft Corporation). In particular, the innovators considered and investigated compromise in computing environments.

Compromise involves a lack of legitimate authority. More precisely, as used herein “compromise” refers to the compromise of a computing system account or a digital identity or a computing system account credential, or a combination thereof. In addition, “compromise” refers to the apparent, likely, or actual use of the compromised item by a person or a service (or both) that lacks legitimate authority for that use. Legitimacy is determined under applicable policies, regulations, and laws.

The innovators observed that service principal account security was insufficiently addressed, and decided that security investments dedicated to service principals and other service accounts could help provide parity with user account security. Service account security is sometimes bundled together with human user account security by tools such as intrusion detection systems, intrusion protection systems, and compromise recovery tools. After thought and investigation, the innovators concluded that this bundling provided an opportunity to improve service principal account security and availability, by unbundling the two kinds of accounts so that service principal accounts and human user accounts are treated differently in certain ways.

The innovators considered a scenario in which an account is flagged as compromised, and the authentication requirements for the account are increased, e.g., by requiring a multifactor authentication (MFA) that was not previously required. For a human user account, this approach makes sense, and it helps protect the account with very little inconvenience to the account's legitimate human user and little if any impact on other people or on their accounts. If a password that was previously sufficient by itself to access the user account must now be supplemented by a biometric credential or a removable hardware key or a one-time passcode sent to a smartphone, for example, then the user account's security is increased with little inconvenience for the person who owns the account and no direct impact on anyone else.

But what if the account is not a user account? If the account is actually a service principal account, or another application identity account, then any service that relies on the account to operate will very likely be degraded or broken entirely by the newly imposed multifactor authentication requirement. Thus, failing to distinguish between service principal accounts and human user accounts increases the risk that a service principal account will be made unavailable, despite efforts to secure all of the accounts, or even in some cases as an inadvertent result of such efforts.

On further consideration and investigation, the innovators also identified other differences between user accounts (a.k.a. “user identity accounts” or “human user accounts”) and application identity accounts that can impact security efforts. For example, it turns out that the data features most helpful in identifying an application identity account compromise differ somewhat from the data features being utilized to identify user account compromise. Also, application identity account compromise detection benefits from a per-credential analysis that is not applicable to human user accounts. This stems from the fact that user accounts generally have a single credential (e.g., a password) or a single set of related credentials (e.g., a password supplemented by MFA), whereas application identity accounts sometimes have multiple credentials that are independent of one another. These and other differences are discussed herein. Accordingly, a set of technical challenges arose, involving the similarities and differences between application identity accounts and user identity accounts with respect to compromise. One may view these as challenges arising from this initial technical question: How specifically may application identity security be improved based on distinctions between application identity accounts and human user accounts?

One constituent technical challenge is to determine at least some of the relevant distinctions between application identity accounts and human user accounts. Some embodiments address this challenge in one or more of the following ways: taking a per-credential approach to compromise detection instead of a per-account approach, tailoring a machine learning anomaly detector with features chosen specifically for application identity accounts, and limiting the proactive responses of access control mechanisms to avoid inadvertently breaking a service.

Another constituent challenge is how to increase the efficiency and accuracy of application identity account security tools that may use machine learning anomaly detection results. Some embodiments address this challenge by applying heuristic rules to anomaly detection results to reduce false positives, or applying heuristic rules to avoid machine learning anomaly detector invocation in particular situations based on mechanisms such as an IP address allowlist or an application identity account age threshold.

Another technical challenge is posed by the relative sparsity of application identity account attacks in comparison to user identity account attacks. One measurement found less than a hundred application identity account attacks among more than two hundred and fifty million user identity account attacks. A related challenge is the extremely large data size, e.g., in one environment daily logs of an evolved security token service consumed more than two hundred terabytes per day. Some embodiments address the sparsity challenge using an isolation forest anomaly detection algorithm, and address the data size challenge using rolling window, aggregation, and big data tools and techniques in a feature engineering pipeline. More details are disclosed below.

More generally, the present disclosure provides answers to these questions and technical mechanisms to address these challenges, in the form of application identity compromise detection functionalities. These functionalities are not strictly limited to detection alone, e.g., they may guide post-detection actions or facilitate detection effectiveness or efficiency, but they include, facilitate, or arise from detection activities. These functionalities may be used in various combinations with one another, or alone, in a given embodiment.

### Operating Environments

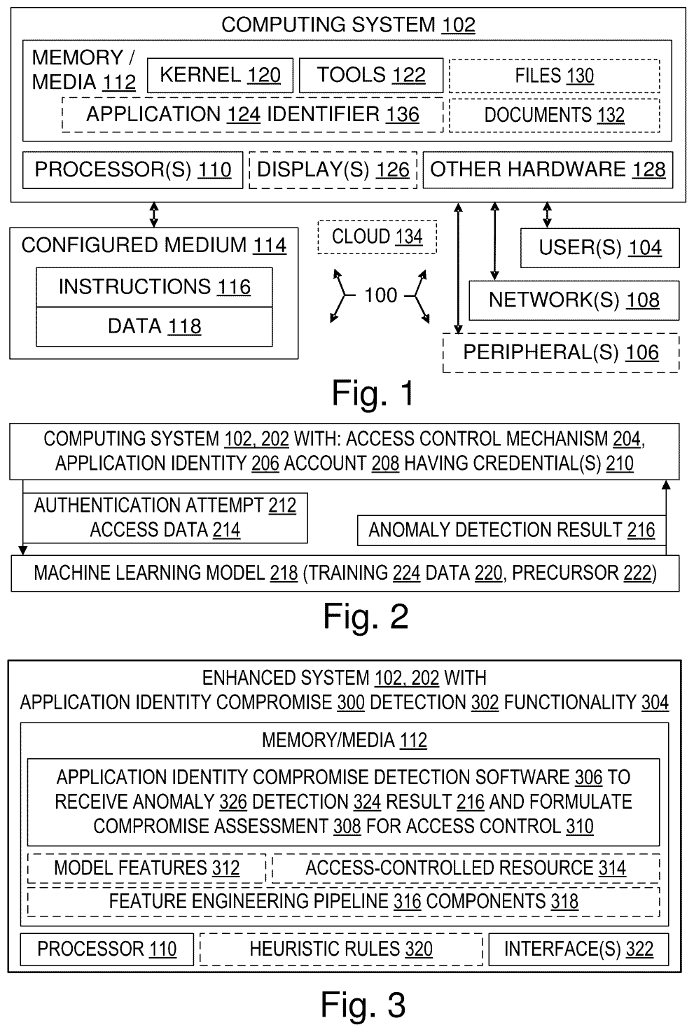

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 134. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of human user 104. Automated agents, scripts, playback software, devices, and the like running or otherwise serving on behalf of one or more humans may also have accounts, e.g., application identity accounts. Sometimes an account is created or otherwise provisioned as a human user account but in practice is used primarily or solely by one or more services; as a result, this is a de facto application identity account. Use of a de facto application identity account by a human is typically limited to (re) configuring the account or to similar administrative or security use.

Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112, also referred to as computer-readable storage devices 112. Documents and other files 130 may reside in media 112. Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, application identity compromise detection functionality could be installed on an air gapped network and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

### More About Systems

FIG. 2 illustrates a computing system 102 configured by one or more of the application identity compromise detection enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an enhanced system 202 which is configured with software 306 to provide application identity compromise detection functionality 304. FIG. 3 items are discussed at various points herein, and additional details regarding them are provided in the discussion of a List of Reference Numerals later in this disclosure document.

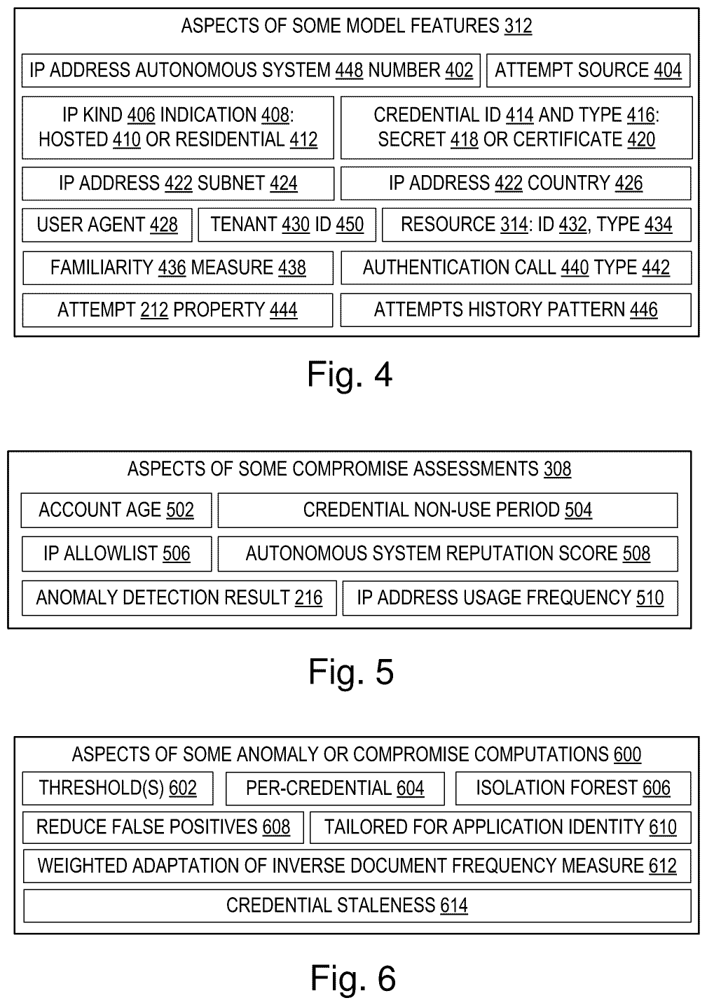

FIG. 4 shows some aspects of data features which are used primarily or solely within or by machine learning models 218. This is not a comprehensive summary of all machine learning models 218 or of every data feature 312. In particular, although it is contemplated that most embodiments will use the FIG. 4 data features 312 primarily or solely for anomaly detection by a model 218, some embodiments may also or instead use one or more of these data features in one or more heuristic rules 320. FIG. 4 items are discussed at various points herein, and additional details regarding them are provided in the discussion of a List of Reference Numerals later in this disclosure document.

FIG. 5 shows some aspects of data features 312 used primarily or solely in compromise assessment 308 calculations that are performed outside a machine learning model 218. This is not a comprehensive summary of all compromise assessment calculations or of every data feature 312 or of all heuristic rules 320. In particular, although it is contemplated that most embodiments will use the FIG. 5 data features 312 primarily or solely during compromise assessment 308 calculations that apply heuristic rules 320 to anomaly detection results 216 provided by a model 218, some embodiments may also or instead use one or more of these data features within the model 218. FIG. 5 items are discussed at various points herein, and additional details regarding them are provided in the discussion of a List of Reference Numerals later in this disclosure document.

FIG. 6 is a block diagram illustrating some functionality 304 aspects to which no presumptive use applies, or which pertain to an entire system 202. That is, it is contemplated that embodiments will exhibit some or all of these aspects for compromise assessment calculations or for machine learning model-based anomaly detection, or both. FIG. 6 items are discussed at various points herein, and additional details regarding them are provided in the discussion of a List of Reference Numerals later in this disclosure document.

In some embodiments, the enhanced system 202 may be networked through an interface 322. An interface 322 may include hardware such as network interface cards, software such as network stacks, APIs, or sockets, combination items such as network connections, or a combination thereof.

In some embodiments, the enhanced system 202 submits access data 214 to a trained machine learning (ML) model 218, gets an anomaly detection result 216 from the trained ML model, forms a compromise assessment 308 using the anomaly detection result, and supplies the compromise assessment to an access control mechanism 204.

In some cases or some embodiments, the anomaly detection result is also used as the compromise assessment 308. But in some others, the anomaly detection result 216 may be modified or even superseded by application of one or more heuristic rules 320 during computation of the compromise assessment 308. For instance, a login deemed anomalous by the model 218 may nonetheless be treated as not being evidence of compromise when the login source 404 is from an IP address 422 on an allowlist 506. Conversely, a login deemed non-anomalous by the model 218 may nonetheless be treated as evidence of compromise when the login source 404 is in an autonomous system 448 which has a reputation score 508 beyond a threshold level 602 of malevolence.

In some cases or some embodiments, application of one or more heuristic rules 320 may limit or modify what access data 214 is submitted to the ML model. For example, an IP address 422 may be mapped 918 to an autonomous system reputation score 508 which is then submitted to the model, or an IP address 422 may be mapped 920 to an IP kind indication 408 that distinguishes hosted IPs 410 from residential IPs 412 and the indication 408 is then submitted to the model.

In some cases or some embodiments, application of one or more heuristic rules 320 increases efficiency by avoiding submission of access data 214 to a computationally expensive ML model 218. For instance, model 218 invocation may be avoided by an embodiment when the login source 404 is from an IP address 422 found 916 on an allowlist 506.

In some embodiments, the enhanced system 202 is configured to detect a compromise 300 impacting an application identity account 208, the application identity account being associated with an application identity 206 as opposed to being associated with any particular user identity 104. The enhanced system 202 includes a digital memory 112 and a processor 110 in operable communication with the memory. The digital memory 112 may be volatile or nonvolatile or a mix. The processor 110 is configured to perform application identity compromise detection steps. The steps include (a) submitting 804 access data 214 to a trained machine learning model 218, the access data representing an authentication attempt 212 which uses the application identity 206, the trained machine learning model tailored 610 for application identity anomaly detection 324 as opposed to user identity anomaly detection, (b) receiving 806 from the trained machine learning model an anomaly detection result 216, (c) formulating 808 a compromise assessment 308 based at least in part on the anomaly detection result, and (d) supplying 810 the compromise assessment for use by an access control mechanism 204, the access control mechanism configured to control access to a resource 314 via the application identity.

In some situations, a compromise assessment will be reported (e.g., via an alert 1508) to a cloud admin, tenant admin, or security person for further investigation. Then that person will decide whether to remove the compromised credentials or take other action.

In some situations, the compromise assessment triggers an automatic proactive action 310 by a control mechanism 204, such as increased logging. However, it is contemplated that the alerted 810 control mechanism 204 will not simply block account access directly in response to a compromise assessment that indicates a compromise has occurred, because such blocking could degrade or break the service. For instance, a stolen credential might be misused by bad actors and also be legitimately used by a service, within a few minutes of each other. Unlike the case of a stolen user account password, a stolen application identity account password therefore does not trigger an automatic proactive account lockout.

Some embodiments include at least two “operably distinct” credentials 210 of the application identity account 208. Herein, credentials which may be employed by or on behalf of different people at the same time are operably distinct. Credentials which have different expiration dates are also operably distinct. Finally, operably distinct credentials have no relationship conditioning use of one on use of the other for authentication to use the account.

For example, if an account accepts either a password or a security token for login authentication and allows more than one logged-in session at a time, then the password and the security token are operably distinct because they can both be employed by or on behalf of different people at the same time. Also, if an account accepts digital certificate A or digital certificate B as a login credential, and if A has a different expiration date than B, then A and B are operably distinct. This is a specific instance of a more general observation that two bitwise different credentials, even of the same type, are operably distinct unless linked by a relationship conditioning use of one on use of the other. Conversely, two instances of the same login password for a given account constitutes one credential, not two. Finally, if a one-time password is accepted as a credential only for MFA to supplement a password hash, then the one-time password and the password hash are not operably distinct credentials.

In general, a service principal or other application identity account may recognize one, two, or more operably distinct credentials. By contrast, human user accounts may have more than one associated credential, but in many cases (particularly for cloud accounts) those credentials are not operably distinct from one another.

Some embodiments include at least two operably distinct credentials 210 of the application identity account 208, and the trained machine learning model 218 is tailored 610 for application identity 206 anomaly detection 324 as opposed to user identity 104 anomaly detection at least in that the trained machine learning model is configured to perform anomaly detection 324 on a per-credential basis 604 such that the anomaly detection result 216 is specific to exactly one of the two credentials 210.

In some embodiments, the trained machine learning model 218 is tailored 610 for application identity anomaly detection as opposed to user identity anomaly detection at least in that the trained machine learning model has been trained and thereby configured using training data 220 which includes at least a specified number of the following features, where the specified number is in the range from one to ten depending on the embodiment: an IP subnet 424 of a source 404 of an attempt 212 to authenticate the application identity; a country 426 as a location of an IP address of a source 404 of an attempt to authenticate the application identity; an autonomous system number 402 of an IP address of a source of an attempt to authenticate the application identity; an indication 408 whether an IP address of a source of an attempt to authenticate the application identity is a hosted IP address 410, 422; a credential type 416 of an offered credential from an attempt to authenticate the application identity, the credential type distinguishing 922 at least between a secret 418 and a non-secret such as a certificate 420; a credential identifier 414 of an offered credential from an attempt to authenticate the application identity; a user agent 428 of a source of an attempt to authenticate the application identity; a resource identity 432 of a resource 314 to which access was sought pursuant to an attempt to authenticate the application identity; a resource type 434 of a resource to which access was sought pursuant to an attempt to authenticate the application identity; or a call type 442 of an attempt to authenticate the application identity.

Some embodiments include a digital representation of at least one heuristic rule 320 tailored to reduce 908 false positive 608 anomaly detection results 216. In some of these, the processor 110 is further configured to formulate 808 the compromise assessment 308 at least in part by applying 906 one or more heuristic rules to the anomaly detection result. In some, the processor 110 is configured to apply 906 one or more heuristic rules to the access data 214.

Some embodiments include a feature engineering pipeline 316. In some, the pipeline 316 includes the following pipeline components 318: at least a specified number N of respective periodic feature logs 1502 over at least N successive periods, tracking raw feature data 312, 118, where the specified number N is in the range from two to ten depending on the embodiment; at least one aggregated feature log 1504 over at least M successive periods, M being in the range from two to N−1, the aggregated feature log tracking an aggregation by credential 210 of raw feature data; and at least one credential history profile, e.g., profile 702, 708, or 710. In some embodiments, the period for periodic feature logs 1502 is daily, but other periods may also be used, e.g., twelve hours, six hours, or one hour.

Some embodiments include at least four respective periodic feature logs over at least N successive periods, tracking raw feature data, e.g., via processed raw security token system logs: RequestID (attempt 212 identifier), AppID 136, TenantID 450, KeyID 414, timestamp, resource 432, IP, User Agent 428, and possibly other features. Some embodiments include at least one aggregated feature log over at least M successive periods, tracking an aggregation by credential of raw feature data, e.g., a Daily Agg by SP-Key. Some embodiments include at least one credential history profile, e.g., an SP-Key History Profile.

In some embodiments, aggregations 1504 are created in a feature engineering pipeline. An aggregation may include an entire day's raw logs by service principals and their respective credentials (or SP-key). The aggregation data contains aggregated statistics for each credential.

Other system embodiments are also described herein, either directly or derivable as system versions of described processes or configured media, duly informed by the extensive discussion herein of computing hardware.

Although specific application identity compromise detection system 202 architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different features 312 for submission to a model as access data 214 or for training the model or both, as well as other technical features, aspects, components 318, mechanisms, rules 320, operational sequences, data structures, or other application identity compromise detection functionality teachings noted herein, for instance, and may otherwise depart from the particular illustrative examples provided.

Processes (a.k.a. Methods)

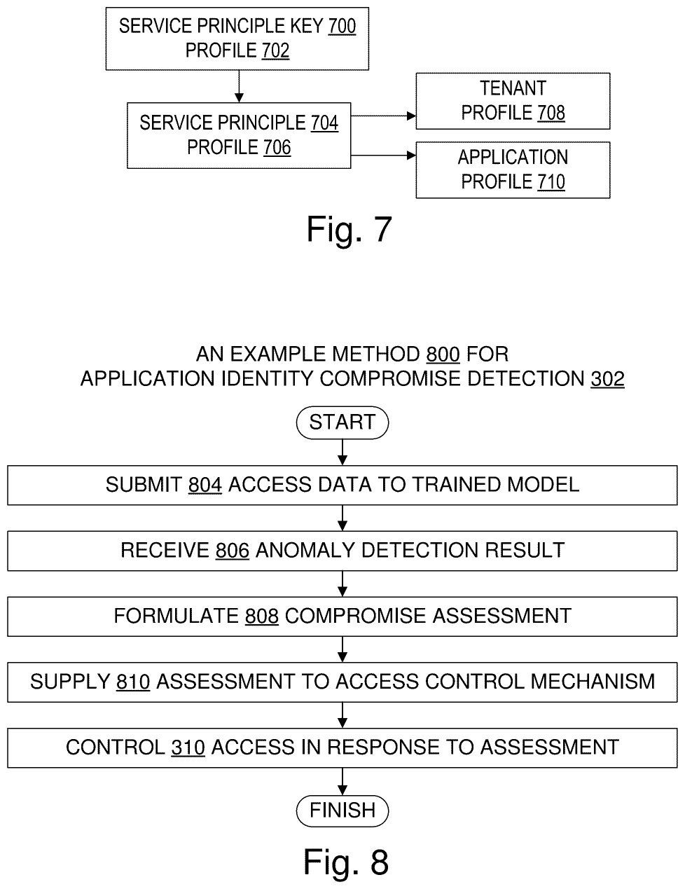

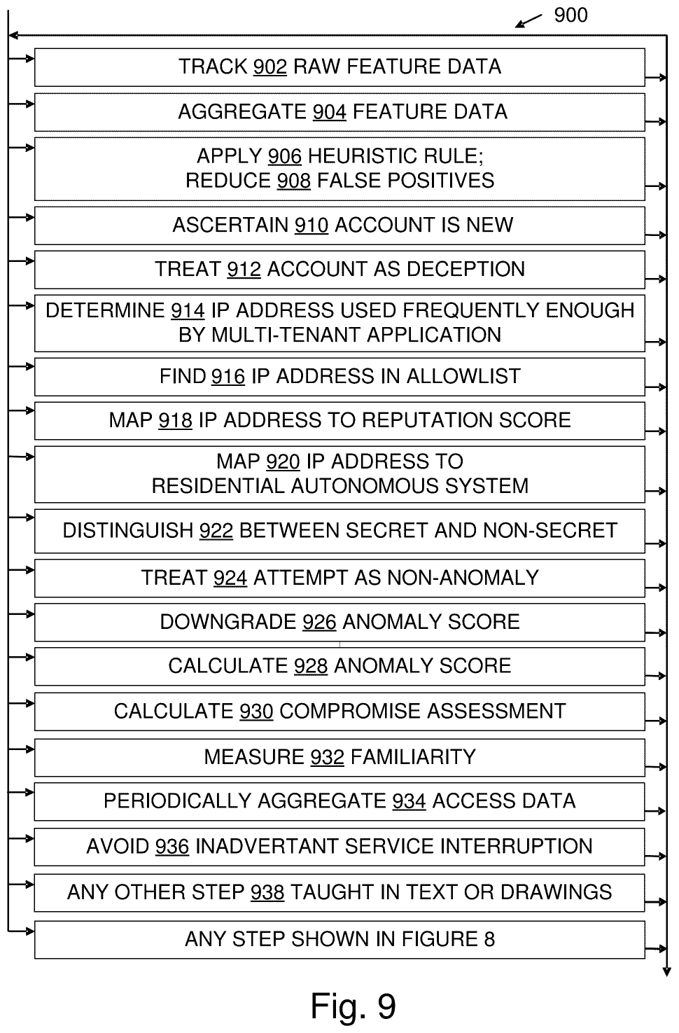

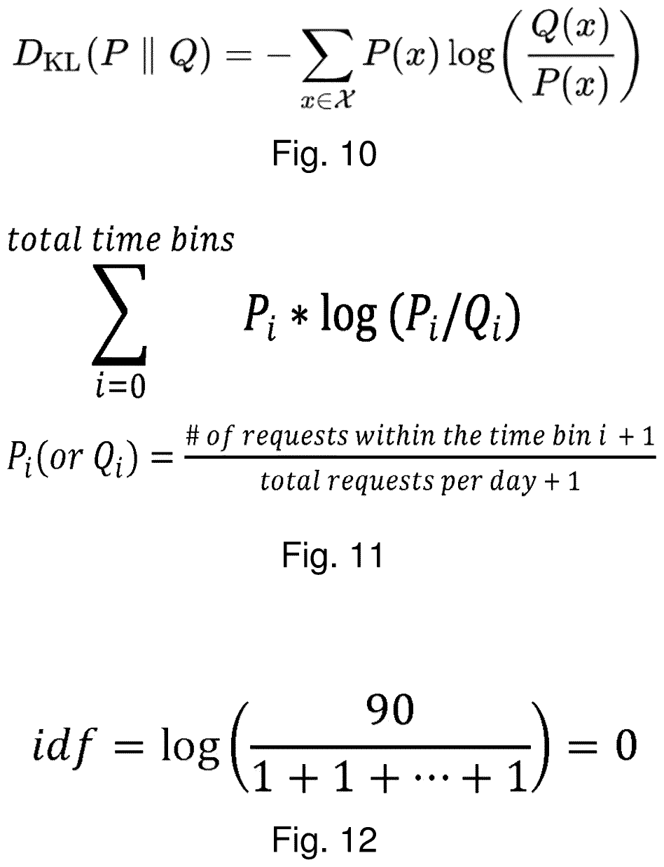

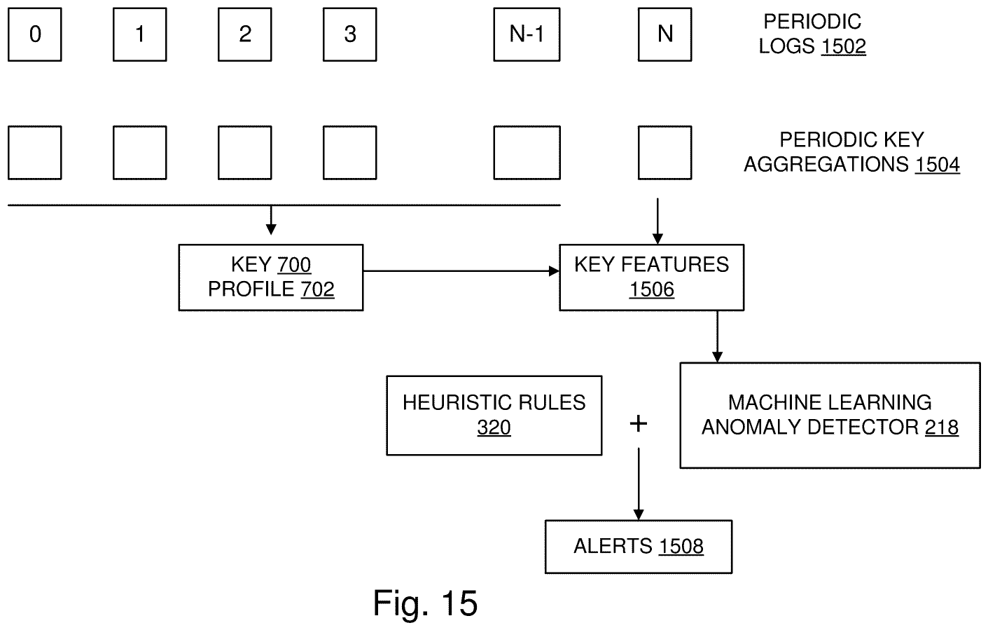

Methods (which may also be referred to as “processes” in the legal sense of that word) are illustrated in various ways herein, both in text and in drawing figures. FIGS. 7 and 15 show aspects of a feature engineering pipeline, and thus illustrate both pipeline structure and pipeline data processing methods. FIGS. 10 through 14 illustrate computational methods using mathematical definitions, equations, or calculations. FIGS. 8 and 9 illustrate families of methods 800, 900 that may be performed or assisted by an enhanced system, such as system 202 or another functionality 304 enhanced system as taught herein. FIG. 9 includes some refinements, supplements, or contextual actions for steps shown in FIG. 8, and incorporates the steps of FIG. 8 as options.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human may manually type in a password which then becomes (or is hashed to produce) submitted 804 access data 214. But no process contemplated as innovative herein is entirely manual or purely mental; claimed processes cannot be performed solely in a human mind or on paper.

In a given embodiment zero or more illustrated steps of a process may be repeated, perhaps with different parameters or data to operate on. Steps in an embodiment may also be done in a different order than the top-to-bottom order that is laid out in FIGS. 8 and 9. Arrows in method or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 800 or 900 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments use or provide a method 900 for detecting a compromise impacting an application identity account, the application identity account associated with an application identity in a cloud 134 as opposed to being associated with any particular user identity, the method performed by a computing system 202, the method including: submitting 805 access data to a trained machine learning model, the access data representing an authentication attempt 212 which uses the application identity, the trained machine learning model tailored 610 for application identity anomaly detection as opposed to user identity anomaly detection; receiving 806 from the trained machine learning model an anomaly detection result; formulating 808 a compromise assessment based at least in part on the anomaly detection result; and supplying 810 the compromise assessment to an access control mechanism which is configured to control 310 access to a resource via the application identity.

In some embodiments, formulating 808 the compromise assessment includes applying 906 at least one of the following heuristic rules to the anomaly detection result: ascertaining 910 that the application identity account is less than a specified age (e.g., two days, or twice the log 1502 period), and in response treating 912 the application identity as a deceptive account created to reduce security; finding 916 an IP address in an allowlist 506 (e.g., per a conditional access policy), and in response either downgrading 926 an anomalousness score otherwise based on the IP address, or designating 924 as non-anomalous an access attempt using the IP address; mapping 918 an IP address to an autonomous system (AS) reputation score, and in response either downgrading an anomalousness score otherwise based on the IP address, or designating as non-anomalous an access attempt using the IP address (a good reputation AS has low risk of use by attackers, per a set threshold 602); mapping 920 an IP address to a residential autonomous system 412, 448, and in response either downgrading 926 an anomalousness score otherwise based on the IP address, or designating 924 as non-anomalous an access attempt using the IP address; or determining 914 that an IP address is used with at least a predetermined frequency 510 by a multi-tenant application 124, and in response either downgrading 926 an anomalousness score otherwise based on the IP address, or designating 924 as non-anomalous an access attempt using the IP address.

Some embodiments use info from other accounts of a tenant to detect anomalies in a service account. In one scenario, a service principal account is usually accessed from X but today it is accessed from Y, which indicates a possible anomaly. If other accounts of the same tenant are also not usually accessed from Y, such an embodiment increases the likelihood that the access from Y is an anomaly. In some of these embodiments, those other accounts in the tenant are also application identity (e.g., service principal) accounts, while other embodiments consider user accounts of the tenant as well as application identity accounts of the tenant.

In some embodiments, the application identity 206 account 208 being monitored for compromise is associated with a tenant identity 450 in the cloud; multiple other accounts 208 are also associated with the tenant identity in the cloud, each of the other accounts not being the application identity account; and the method further includes calculating 928 the anomaly detection result or calculating 930 the compromise assessment or both, based on an application identity account familiarity measure 438 and a tenant accounts familiarity measure 438.

In some embodiments, an application identifier 136 plus a tenant identifier 450 operates as a service principal identifier 206. If the same application identifier 136 is used in a different tenant, there will be two different service principal IDs.

In some embodiments, the application identity account familiarity measure is based at least on familiarity 436 over time of a particular access data feature 312 to the application identity account or familiarity 436 over time of a credential of the application identity account. The tenant accounts familiarity measure is based at least on familiarity 436 over time of the particular access data feature 312 to at least two of the multiple other accounts.

Some embodiments utilize per-credential anomaly detection by the ML model and per-credential compromise assessment by the compromise detection method as a whole. In some, submitting 804 access data to the trained machine learning model includes submitting a credential identifier 414 of a credential that was offered for authentication of the application identity 206, and the anomaly detection result 216 is specific 604 to the credential as opposed to pertaining to the application identity overall. In some of these, the compromise assessment is also specific 604 to the credential as opposed to pertaining to the application identity overall.

Some embodiments detect one or more particular compromise situations. Compromise may happen, for example, when attackers are authenticated to a service principal account by reusing existing credentials on a service principal, or by adding new credentials to the service principal, thus allowing an attacker to access the resources 314 which can be accessed by the service principal. Knowing whether the misused credential is new or familiar may facilitate investigation, e.g., by helping identify a modus operandi to narrow a pool of suspects, or by suggesting which other credentials should be investigated for possible misuse.

In some embodiments and some situations, the compromise assessment 308 indicates that an authentication credential 210 that is familiar to the application identity account has been used in an anomalous way to gain access to the application identity account. In some embodiments and some situations, the compromise assessment 308 indicates that an authentication credential that is not familiar to the application identity account has been used to gain access to the application identity account.

In some embodiments, the method includes calculating 928 the anomaly detection result or calculating 930 the compromise assessment or both, based on a credential type 416 of an offered credential from an attempt to authenticate the application identity. The credential type distinguishes 922 at least between secrets and non-secrets (e.g., security tokens or certificates).

In some embodiments, the method includes calculating 928 the anomaly detection result or calculating 930 the compromise assessment or both, based on a credential staleness 614 measure which indicates whether a credential is being offered for authentication after the credential has not been used for authentication during a non-use period 504. For example, a credential unused for at least two weeks may be considered stale.

Some embodiments include training 224 a precursor machine learning model 222 to produce the trained machine learning model 218 that is tailored for application identity anomaly detection as opposed to user identity anomaly detection.

In some, training 224 includes training the precursor machine learning model using access data 214, 220 that is specific to the application identity and also using access data 214, 220 that is specific to a tenant that includes the application identity.

In some, training 224 includes training the precursor machine learning model using access data 214, 220 that is specific to a tenant 430 that includes the application identity while avoiding training which uses access data that is specific to the application identity 206 when the application identity has an age less than a specified age (e.g., three days).

In some, training 224 includes training the precursor machine learning model using access data 214, 220 that is specific to the application identity and also using access data that is specific to a tenant that includes the application identity and also using access data that is specific to a multi-tenant application program 124 that includes the application identity.

Some embodiments train 224 using application identity level data 214, 220, tenant-level data 214, 220, and application level data 214, 220.

Note that the application identity (e.g., service principal) data that is used to train 224 the ML model is not necessarily data of the same application identity that's being checked 900 later with the trained model for anomalous sign-ins. Service principals used to train the model could be different than service principals for which the model predicts anomalies.

Some embodiments use both current login data 214 and historic traffic pattern 446 data to detect application identity compromise, e.g., comparing frequency by hour over the past three hundred days with frequency per hour during a recent sign-in. Departure from the historic traffic pattern 446 indicates increased risk. In some embodiments, calculating 928 an anomaly detection result for an application identity account access is based on both a property 444 (e.g., one or more features 312 in the access data 214) that was used in the authentication attempt and a Kullback-Leibler divergence of the authentication attempt.

In some embodiments, a modified Kullback-Leibler divergence value is used. FIG. 10 is a formula defining an unmodified Kullback-Leibler divergence measure, and FIG. 11 is a definition of a modified Kullback-Leibler divergence measure. The modification shown is the addition of “+1” to prevent a zero denominator. Similar modifications adding other positive values could also be used in alternate embodiments, e.g., “+2”, “+0.2”, and so on.

In some embodiments, the modified Kullback-Leibler divergence measure captures a traffic distribution, e.g., an hourly traffic distribution. For example, consider a scenario in which an IP address has been used to login with one request every hour before today, and then the same IP address (or a same set of IP addresses such as a subnet) is a source of thousands of requests at 2 AM today. A familiarity measurement won't catch this activity surge because the IP has been seen every day before. But the modified Kullback-Leibler divergence will catch this surge because it compares the hourly traffic distribution values. The surge can then computationally influence an anomaly detection result or a compromise assessment, or both.

In some embodiments, calculating 928 an anomaly detection result for an application identity account access is based on an indication 408 whether an IP address of a source of an attempt to authenticate the application identity is a hosted IP address 410, 422. Hosted addresses are more suspect than residential addresses 412, 422.

### Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as compromise detection software 306, trained models 218, anomaly detection results 216, heuristic rules 320, and compromise assessments 308, in the form of data 118 and instructions 116, read from a removable storage medium 114 and/or another source such as a network connection, to form a configured storage medium. The configured storage medium 112 is capable of causing a computer system 102 to perform technical process steps for application identity compromise detection, as disclosed herein. The Figures thus help illustrate configured storage media embodiments and process (a.k.a. method) embodiments, as well as system and process embodiments. In particular, any of the process steps illustrated in FIGS. 7-15, or otherwise taught herein, may be used to help configure a storage medium to form a configured storage medium embodiment.

Some embodiments use or provide a computer-readable storage device 112, 114 configured with data 118 and instructions 116 which upon execution by at least one processor 110 cause a computing system to perform a method for detecting a compromise of a credential of an application identity account, the application identity account associated with an application identity as opposed to being associated with any particular user identity. This method includes: performing at least one of the following: calculating 928 an anomaly detection result for the application identity account access, or applying 906 a heuristic rule 320 to the application identity account access; formulating 808 a compromise assessment based at least in part on a result of the performing; and supplying 810 the compromise assessment to an access control mechanism which is configured to control access to a resource via the application identity. Calculating 928 the anomaly detection result includes a trained machine learning model 218 calculating 928 the anomaly detection result, the trained machine learning model tailored 610 for application identity anomaly detection as opposed to user identity anomaly detection. Also, the heuristic rule 320 is tailored to reduce false positives 608.

In some embodiments, calculating 928 the anomaly detection result is performed at least in part by measuring 932 a familiarity 436 using a weighted adaptation 612 of an inverse document frequency (IDF) measure.

To help illustrate IDF and familiarity, FIG. 12 is an example of an adapted non-weighted inverse document frequency calculation familiarity measure for a scenario in which the number of days a service principal is active (90) is divided by a summation of accesses to the service principal from a given IP address (1+1+ . . . +1) to yield log(90/90)=log(1)=0 when the service principal has been active each of the past 90 days. If the service principal had been accessed only two of the past 90 days, the calculation would be log(90/2)=3.8 (truncating). In this example, “log” means natural log, which may also be written as “ln”. Days are an example of a logging period; other periods such as 12 hours, 6 hours, or one hour (among others) may be used instead.

Because a service principal is an example of an application identity 206, this FIG. 12 example helps illustrate application identity level familiarity measures. Tenant level familiarity measures may be defined similarly, e.g., a non-weighted tenant-level IDF familiarity measure may be defined as log (the number of days a tenant is active/a summation of accesses to the tenant from a given IP address). An application-level non-weighted tenant-level IDF familiarity measure may be defined as log (the number of days active apps in a given tenant/a summation of accesses to any of the apps from a given IP address). The remarks above regarding “log” and use of other periods also apply to these familiarity measures.

Some embodiments use one or more weighted IDF familiarity measures instead of non-weighted familiarity measures. To illustrate why, consider a scenario in which an application has 10,000 daily login requests in the past 90 days. If there is one login request from IP1 422 per day, the non-weighted familiarity is log(90/90)=0. If there are 5000 login requests from IP2 422 per day, the non-weighted familiarity is also log(90/90)=0. Thus, the non-weighted calculation fails to distinguish login activities based on how many login requests were made per day, which deprives that data of impact during the compromise detection.

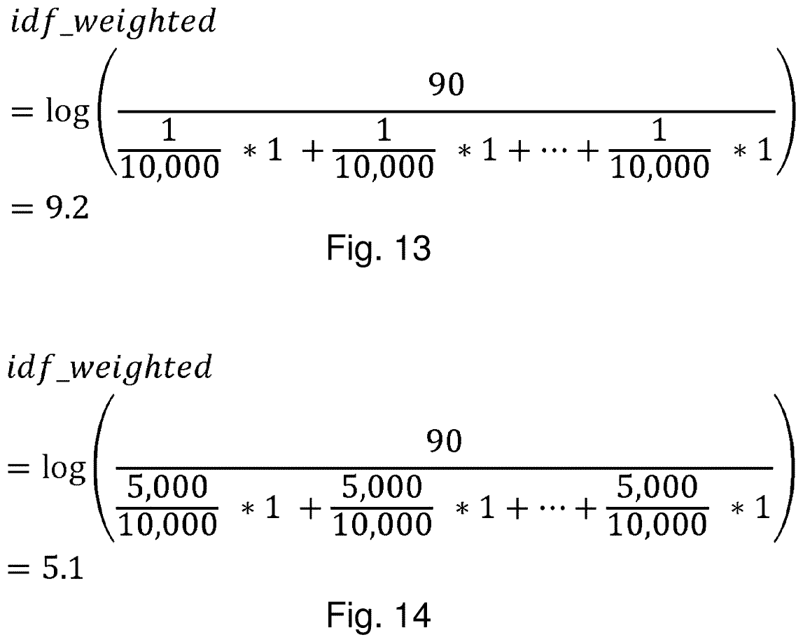

FIGS. 13 and 14 show a weighted familiarity approach that utilizes the distinction missed by the non-weighted approach, in the same scenario of an application that has 10,000 daily login requests in the past 90 days. FIG. 13 shows a weighted IDF calculation involving one login request per day from the first IP address IP1, and FIG. 14 shows a weighted inverse document frequency calculation involving five thousand login requests per day from the second IP address IP2. Weighted tenant-level familiarity measures and weighted application-level familiarity measures are defined similarly.

In some embodiments, calculating 928 the anomaly detection result is performed at least in part by using an isolation forest 606.

In some embodiments, the method includes periodically aggregating 934 at least two of the following: an application program identifier 136 of an application program 124 that is associated with the application identity; a tenant identifier 450 of a tenant 430 that is associated with the application identity; or a credential identifier 414 of an offered credential from an attempt to authenticate the application identity.

In some embodiments which calculate 928 the anomaly detection result, the trained machine learning model is tailored 610 for application identity anomaly detection as opposed to user identity anomaly detection at least in that the trained machine learning model has been trained 224 and thereby configured using training data which includes at least a specified number of the following features (the specified number in the range from three to ten, depending on the embodiment): an IP subnet 424 of a source of an attempt to authenticate the application identity; a country 426 as a location of an IP address of a source of an attempt to authenticate the application identity; an autonomous system number 402 of an IP address of a source of an attempt to authenticate the application identity; an indication 408 whether an IP address of a source of an attempt to authenticate the application identity is a hosted IP address; a credential type 416 of an offered credential from an attempt to authenticate the application identity, the credential type distinguishing at least between a secret and a non-secret; a credential identifier 414 of an offered credential from an attempt to authenticate the application identity; a user agent 428 of a source of an attempt to authenticate the application identity; a resource identity 432 of a resource to which access was sought pursuant to an attempt to authenticate the application identity; a resource type 434 of a resource to which access was sought pursuant to an attempt to authenticate the application identity; or a call type 442 of an attempt 440 to authenticate the application identity.

### Additional Observations

Additional support for the discussion of application identity compromise detection herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, additional examples and observations are offered.

### Technical Character

The technical character of embodiments described herein will be apparent to one of ordinary skill in the art, and will also be apparent in several ways to a wide range of attentive readers. Some embodiments address technical activities such as logging into a computer account 208, authenticating 212 a login, training 224 a machine learning model 218 or 222, and calculating 928 an anomaly detection score, which are each an activity deeply rooted in computing technology. Some of the technical mechanisms discussed include, e.g., machine learning models 218, application identity compromise detection software 306, heuristic rules 320, feature engineering pipelines 316, familiarity measures 338, and traffic patterns 446. Some of the technical effects discussed include, e.g., detection 302 of application identity compromises 300 despite relative scarcity and despite big data, improved security of application identities 206 in comparison to security provided by tools or techniques that bundle application identity accounts with human user accounts, and avoidance of inadvertent reductions or failures of service availability due to authentication requirements. Thus, purely mental processes and activities limited to pen-and-paper are clearly excluded. Other advantages based on the technical characteristics of the teachings will also be apparent to one of skill from the description provided.

Some embodiments described herein may be viewed by some people in a broader context. For instance, concepts such as availability, awareness, case, efficiency, or user satisfaction, may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to automatically and effectively increase the security of service principals and other application identities. Other configured storage media, systems, and processes involving availability, awareness, case, efficiency, or user satisfaction are outside the present scope. Accordingly, vagueness, mere abstractness, lack of technical character, and accompanying proof problems are also avoided under a proper understanding of the present disclosure.

### Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples, operating environments, time period examples, software process flows, security tools, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

Some embodiments provide or utilize a method for detecting application identity account compromise from sign-in anomalies. In some scenarios, an important aspect of an organization's zero trust approach is securing application identities. Some embodiments taught herein build upon Azure® Active Directory® Identity Protection capabilities (marks of Microsoft Corporation), or other identity and access management capabilities, as a foundation in detecting identity-based threats, by effectively expanding that foundation to include threat detection for applications and service principals. A suspicious sign-ins algorithm 306 detects sign-in properties 444 or patterns 446 that are unusual for a given service principal and hence may be an indicator of compromise.

In some embodiments, the detection functionality 304 baselines sign-in behavior between two and sixty days, and fires an alert 1508 if one or more of the following unfamiliar properties 444 occur during a subsequent sign-in: IP address 422 or ASN 402, target resource 314, user agent 428, indication 408 of hosting versus non-hosting IP or indication 408 of a change in that hosting status, IP country 426, or credential type 416. An identity protection functionality marks accounts at risk when this detection fires an alert because this can indicate account takeover for the subject application identity. That said, legitimate changes to an application's configuration may sometimes cause a false positive from an anomaly detector 218, e.g., via an anomaly of the account plus an anomaly of the tenant (organization), a pivot around the credential, suppression anomalies in trusted locations, anomalous traffic volume, anomalous credential type, or use of an old credential. Heuristics are applied to reduce false positives.

In some embodiments, compromise detection for service principal accounts is based on detecting an account's anomalous behavioral patterns. Access data 214 is collected, e.g., by Azure® Active Directory® Secure Token Service during a sign-in phase. When multiple credentials can be added to the service principal account, specific credentials that are potentially compromised are reported. The compromise of a credential is detected by pre-trained machine learning models, which detect anomalies of new login behavior from historical behavior patterns. Customers can view these alerts, e.g., through a Microsoft Graph™ API (mark of Microsoft Corporation).

In some computing environments, a service principal is an account not related to any particular user 104. It is a concrete instantiation of an application 124, created in a tenant, and it inherits some properties from a global application object. The service principal object defines, e.g., what the app 124 can do in the specific tenant, who can access the app, and what resources 314 the app can access. Authentication with a service principal can be done through credentials which are either secrets 418 or certificates 420, for example. Multiple secrets or certificates can be added to a single service principal. Compromise happens when attackers are authenticated for access to the service principal by reusing existing credentials on a service principal, or by adding new credentials to the service principal, whereby the resources that can be accessed by the service principal will also be accessible to the attackers.

In some embodiments, device information, geo location, timestamp, and other data 214 are collected from service principal authentication request logs through Azure® Active Directory® Secure Token Service. Raw features of credentials of service principals are extracted from the raw logs and additional features (such as aggregated features) are also added. Then credentials and corresponding features are inserted into a credential profile 702.

The credential profile captures a historical login related pattern for each service principal's credential. In some embodiments, the profile is in a key-value format, which can be stored in a distributed key-value store database for real time usage purpose, or on HDFS for offline usage purpose. An important pivot of the credential profile is the credential ID. Profile values include or are derived from raw features from historical authentication requests. To avoid unnecessary storage costs, only the most recent X day's features are kept, therefore, a queue with fixed size is maintained for every credential, and features from the oldest day will be retired if the queue becomes full.

In some embodiments, machine learning (ML) features are created based on a comparison of behavioral patterns between a new login and historical logins, in addition to known instances of account compromise 300 from past security incidents. The patterns are described from different perspectives, such as device, geographic location, login timing, login frequency, and so on. An isolation forest is built based on these features. Credentials with anomalous behavioral patterns are detected by the isolation forest model 218. Additional policies 320 and heuristic rules 320 are added on top of the ML-anomaly detection results so that most of the false positives are removed. Eventually, alerts with these suspicious credentials are picked by a signal pipeline (e.g., as part of Azure® Active Directory® Identity Protection) and eventually become accessible by customers, e.g., through a Microsoft Graph™ API.

One example computing environment and test implementation included a Daily Agg 1504 by SP-Key: AppID, TenantID, KeyID, agg_statistics, 40 GB/day, via a daily job, e.g., on Cosmos™ (mark of Microsoft Corporation) or Spark™ (mark of The Apache Software Foundation). This example also included SP-Key History Profile 702: AppID, TenantID, KeyID, agg_statistics from Day0 to Day (n−1), Queue size: 60 (days), Remove Key if being inactive>1 year; code to create queue from day 0, and code to cumulate queue every day.

This example also included Features: AppID, TenantID, KeyID, at SP-level, Tenant-level, Application-level. A data flow went SP-Key Profile->Agg by (AppID+TenantID)->SP Profile, as illustrated in FIG. 7 by the arrow from service principal key profile 702 to service principal profile 706. As to SP-level Familiar Features, this example compared today's key-level feature vs. SP-level Profile, e.g., Today: Key0--{23.11.21.9, 23.11.20.8}, SP profile: idf for each IP, Choose the max idf as IDF for IP dimension (IDF_IP). Further as to SP-level Familiar Features, this example used IDF_IP, IDF_ASN, IDF_Resource, IDF_UA, IDF_Country, etc. and Hourly Traffic Pattern Distance.

FIG. 7 also illustrates an aggregation 904 by TenantID 450, indicated by the arrow from service principal profile 706 to tenant profile 708, and an aggregation 904 by AppID 136, indicated by the arrow from service principal profile 706 to application profile 710.

In this example, the service principal profile 706 includes SP-level familiar features IDF_IP 422, IDF_ASN 402, IDF_Resource 432, IDF_UA 428, IDF_Country 426, and potentially others depending on the embodiment, as well as an Hourly Traffic Pattern Distance 446.

In this example, the tenant profile 708 includes Tenant-level familiar features IDF_IP 422, IDF_ASN 402, and IDF_UA 428.

In this example, the application profile 710 includes App-level familiar features IDF_IP 422, IDF_ASN 402, and IDF_UA 428.

In some embodiments, the pipeline 316 also has a data flow SP-Key Profile->Agg by (AppID+TenantID)->SP-level features, and a data flow in which (SP-level features, Tenant-level features, App-level features, D2C)->Append features to Key-SP. Appending features to Key-SP may be done when creating an SP-level features table.

In some embodiments, modeling 218 includes an SP segmentation into Active SP (Features: SP-level, tenant level), Inactive SP for SPs with <3 active days in the profile (Features: tenant level only, contains any newly created SP), and SP of Multi-tenant App (Features: SP-level, tenant level, application level). In a variation, some embodiments only build allowlist rules using app-level features on the top of ML score for the segment containing SP(s) of Multi-tenant App(s).

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GPU: graphical processing unit
GUI: graphical user interface
GUID: globally unique identifier
HDFS: Hadoop® distributed file system (mark of The Apache Software Foundation)
IaaS or IAAS: infrastructure-as-a-service
ID: identification or identity
LAN: local area network
OS: operating system
PaaS or PAAS: platform-as-a-service
RAM: random access memory
ROM: read only memory
TPU: tensor processing unit
UA: user agent
UEFI: Unified Extensible Firmware Interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin (x)) or it may simply return without also providing a value (e.g., void functions).

“Service” means a consumable program offering, in a cloud computing environment or other network or computing system environment, which provides resources to multiple programs or provides resource access to multiple programs, or does both.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Application identity compromise detection operations such as training or invoking a machine learning model 218, processing data 118 into usable features 312 in a pipeline 316, calculating 928 an anomaly score 216, applying 906 heuristic rules 320, and many other operations discussed herein, are understood to be inherently digital. A human mind cannot interface directly with a CPU or other processor, or with RAM or other digital storage, to read and write the necessary data to perform the application identity compromise detection steps taught herein even in a hypothetical prototype situation, much less in an embodiment's real world environment 100 that has thousands of daily login requests 212 and gigabytes of daily log 1502 data. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as aggregating, alerting, applying, ascertaining, calculating, controlling, detecting, determining, distinguishing, downgrading, finding, formulating, mapping, measuring, receiving, reducing, submitting, supplying, tracking, treating (and aggregates, aggregated, alerts, alerted, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment
102 computer system, also referred to as a “computational system” or “computing system”, and when in a network may be referred to as a “node”
104 users, e.g., user of an enhanced system 202; refers to a human or a human's online identity unless otherwise stated
106 peripherals
108 network generally, including, e.g., LANs, WANs, software-defined networks, clouds, and other wired or wireless networks
110 processor
112 computer-readable storage medium, e.g., RAM, hard disks
114 removable configured computer-readable storage medium
116 instructions executable with processor; may be on removable storage media or in other memory (volatile or nonvolatile or both)
118 data
120 kernel(s), e.g., operating system(s), BIOS, UEFI, device drivers
122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, and so on
124 applications, e.g., word processors, web browsers, spreadsheets, games, email tools, commands
126 display screens, also referred to as “displays”
128 computing hardware not otherwise associated with a reference number 106, 108, 110, 112, 114
130 file, blob, table, container, or other digital storage unit(s)
132 computational service, e.g., storage service, kernel service, communications service, provisioning service, monitoring service, daemon, interrupt handler, networking service, virtualization service, identity service, etc.
134 cloud
136 application identifier; digital
202 system 102 enhanced with application identity compromise detection functionality 304
204 access control mechanism, e.g., identity and access management software, intrusion detection or prevention software, exfiltration prevention software, role-based access control software, authentication or authorization software, other cybersecurity software
206 application identity, as opposed to human user identity or human user account identity; digital or computational or both; application identity accounts operate mostly or entirely to provide services with access to resources, as opposed to human identity accounts which operate mostly or entirely on behalf of a particular person (“mostly or entirely” may be quantified, e.g., by logins, resource usage, or express categorization on account creation); some examples include Microsoft® application service principals (mark of Microsoft Corporation), Amazon Web Services® Identity Access Management Roles (mark of Amazon Technologies, Inc.), Google® service account identities (mark of Google, LLC)
208 computing environment account
210 computing environment account credential; digital; may also be referred to as a “key” especially when the credential includes or is secured by an encryption key
212 authentication attempt, e.g., attempt to login or sign-in or log on or sign on (these are treated as interchangeable herein) to an account 208; includes successful and unsuccessful attempts unless otherwise indicated
214 access data, e.g., data 118 representing a login attempt source or a login attempt itself, or both
216 anomaly detection result, e.g., anomaly score (a.k.a. anomalousness score or classification or prediction); an anomaly score may be Boolean, or a non-negative integer, or a value in a range from 0.0 to 1.0, for example; in addition to an anomaly score, an anomaly detection result may in some embodiments include an explanation of the basis for the score, e.g., one or more of “unfamiliar IP”, “unfamiliar ASN”, “unfamiliar IP country”, “unfamiliar tenant IP”, “unfamiliar tenant UA”, “unfamiliar tenant ASN”, “unfamiliar resource”, “unfamiliar UA”, “anomalous hosting traffic”, “anomalous resource traffic”, “anomalous credential traffic”, “anomalous ASN traffic”, or the like
218 machine learning model; computational
220 training data for training a machine learning model 218 or 222
222 precursor machine learning model; computational
224 computationally training a machine learning model 218 or 222
300 compromise of an account or an identity or both
302 detection of application identity compromise
304 application identity compromise detection functionality, e.g., functionality which performs at least steps 806 or 808, or a trained 610 model 218, or a feature engineering pipeline 316, or an implementation providing functionality for any previously unknown method or previously unknown data structure shown in any Figure of the present disclosure
306 application identity compromise detection software, e.g., software which performs any method according to any of the Figures herein or utilizes any data structure according to any of the Figures herein in a manner that facilitates application identity compromise detection 308 compromise assessment; digital
310 access control, e.g., computational action by an access control mechanism 204 or other computational action which controls access to a resource 314; computationally control access to a resource, e.g., by imposing an access condition or requirement
312 feature; digital; e.g., data used to train 224 a model 218 or submitted 804 to a model 218
314 resource, e.g., file 130, virtual machine or other digital artifact, application 124, kernel 120, portion of memory 112, processor 110, display 126 or peripheral 106 or other hardware 128
316 feature engineering pipeline; digital and computational
318 pipeline component, e.g., portion or part of pipeline 316, e.g., any item named or having a reference numeral in FIG. 7 or FIG. 15
320 heuristic rule; computational or digital or both
322 interface generally to a system 102 or portion thereof; may include, e.g., shells, graphical or other user interfaces, network addresses, APIs, network interface cards, ports
324 detection of application identity anomaly; computational or digital result
326 application identity anomaly; data characteristic or computational result
402 autonomous system number (ASN); digital
404 source of authentication attempt, as represented by one or more digital values, e.g., IP address, ASN, country, etc.
406 kind of IP, namely, hosted or non-hosted (residential)
408 digital indication of kind 406; may be explicit (e.g., bit set for hosted and clear for non-hosted) or implicit in IP address or ASN
410 hosted IP address(es); also refers to state of being hosted; digital; e.g., IP address provided via Amazon Web Services®, Microsoft Azure®, Google® Cloud Platform, etc. (marks of their respective owners)
412 residential IP address(es); also refers to state of being residential; digital; e.g., IP address provided by an Internet Service Provider to a residential customer
414 credential identifier, e.g., password hash, certificate hash, certificate number, index of a credential in an array or table or list of credentials
416 type of credential, e.g., secret or non-secret; digital
418 secret, e.g., a password, password hash, or encryption key; digital
420 digital certificate or security token; an example of a non-secret type of credential; digital
422 IP address (IPv4 or IPv6); digital
424 IP address subnet or other group of IP addresses
426 digital identifier of a country associated with an IP address
428 digital description of user agent, e.g., in a web communication
430 cloud tenant, e.g., organization having multiple accounts in a cloud
432 digital identifier of a resource 314
434 type of a resource 314; digital; may distinguish, e.g., virtual machines from pure storage resources or distinguish between virtual machines, may indicate a resource owner, may indicate resource version or size or age or jurisdiction
436 familiarity of an item to a particular context, e.g., familiarity of an IP address in accesses to a given resource; digital
438 familiarity measure; computation of a value representing a familiarity or a digital result of such a computation
440 authentication call, e.g., invocation of an authentication API

442 authentication call type; method name or other digital artifact indicating, e.g., which authentication protocol is invoked; in some Microsoft environments some examples are: “OAuth2: Token”, “OfficeS2SOAuth2: Token”, and “RegionalCacheAuth: regionalcacheauthtoken”
444 property of an authentication attempt, e.g., credential or type of credential offered, digital value associated with attempt source 404, timestamp, result of attempt (e.g., immediate success, success after additional authentication such as MFA or human review, immediate failure, failure after request for additional authentication); a feature 312 or group of features 312 may serve as a property 444
446 digital artifact representing a historic pattern of login attempts or aspects thereof, e.g., IP addresses of sources of login attempts
448 autonomous system; part of the global IP address infrastructure
450 digital identifier of a cloud tenant
502 age of an account; digital
504 period of non-use of a credential; digital; may be given by start-date and end-date or by duration prior to current date, for example
506 IP address allowlist; digital
508 ASN reputation score; digital
510 IP address usage frequency; may be a single value or a distribution, for example; digital
600 computations
602 threshold value used computationally
604 characteristic of computation distinguishing on basis of credential ID 414 or otherwise operating on a per-credential basis that distinguishes between individual credentials
606 isolation forest algorithm, or model which computes according to an isolation forest algorithm
608 characteristic of a computation having a tendency to reduce false positives; 608 may also refer to false positives themselves, e.g., a result indicating compromise when there is actually no compromise
610 characteristic of a computation or an artifact (e.g., a model 218) being designed for, or operating more efficiently or effectively on, or otherwise tailored for application identity as opposed to user identity or to identity generally
612 inverse document frequency computation adapted for use in compromise detection, or a result of such computation; may be weighted or non-weighted, but weighted is presumed
614 staleness of a credential; digital; staleness may be a result, e.g., of a sufficiently long period of non-use or of a version change (older version is staler than newer one)
700 service principal key, e.g., a service principal credential
702 service principal key profile; digital artifact
704 service principal; an example of an application identity 206 often used in Microsoft computing environments
706 service principal profile; digital artifact
708 tenant profile; digital artifact
710 application profile; digital artifact
800 flowchart; 800 also refers to application identity compromise detection methods illustrated by or consistent with the FIG. 8 flowchart
804 computationally submit access data to a trained model, e.g., via an API
806 computationally receive an anomaly detection result, e.g., via an API
808 computationally formulate a compromise assessment
810 computationally supply a compromise assessment to an access control mechanism, e.g., via an API
900 flowchart; 900 also refers to application identity compromise detection methods illustrated by or consistent with the FIG. 9 flowchart (which incorporates the steps of FIG. 8)
902 computationally track raw feature data, e.g., by logging
904 computationally aggregate feature data, e.g., by extracting logged data of a particular field and performing summation, filtering or other operations
906 computationally apply a heuristic rule
908 computationally reduce false positives
910 computationally ascertain that an account is newer than a stated threshold
912 computationally treat an account as a deception, e.g., by restricting access by or through the account
914 computationally determine that an IP address is used more than a specified threshold amount
916 computationally find an IP address in an allowlist
918 computationally map an IP address to a reputation score
920 computationally map an IP address to a particular kind 406
922 computationally distinguish between secrets 418 and non-secrets
924 computationally treat a feature or other item as non-anomalous, e.g., by operating as if the anomaly detector score assigned did not surpass a threshold marking anomalousness
926 computationally downgrade and anomaly score, by operating as if the anomaly detector score assigned was less indicative of anomalousness
928 calculate an anomaly score or result using a model 218
930 compute a compromise assessment, possibly using an anomaly detection result 216
932 computationally measure a familiarity 436
934 computationally and periodically aggregate access data
936 computationally avoid inadvertent service interruptions, e.g., by not imposing MFA requirement in response to detection of a compromise when the compromised credential is an application identity account credential
938 any step discussed in the present disclosure that has not been assigned some other reference numeral

### CONCLUSION

In short, the teachings herein provide a variety of application identity compromise detection functionalities 304 which operate in enhanced systems 202. Some embodiments improve the security of service principals 704, service accounts 208, and other application identity 206 accounts 208 by detecting 302 compromise 300 of account credentials 210. Application identity 206 accounts 208 provide computational services 132 with access to resources 314, as opposed to human identity 104 accounts 208 which operate on behalf of a particular person 104. Authentication attempt 212 access data 214 is submitted 804 to a machine learning model 218 which is trained 224 specifically 610 to detect 324 application identity account anomalies 326. Heuristic rules 320 are applied 906 to the anomaly detection result 216 to reduce 908 false positives 608, yielding 808 a compromise assessment 308 that is suitable for access control mechanism 204 usage 310. Embodiments reflect differences between application identity 206 accounts and human identity 104 accounts, in order to avoid 936 inadvertent service interruptions, improve compromise 300 detection 302 for application identity 206 accounts, and facilitate compromise 300 containment efforts or recovery efforts or both by focusing 604 on a credential 210 individually instead of an account 208 as a whole. Aspects of familiarity 436 measurement 438, model feature 312 selection 224 or 804 or both, and a model 218 feature 312 engineering pipeline 316 are also described. Other aspects of application identity compromise detection functionality 304, and its technical advantages, are also described herein.

Embodiments are understood to also themselves include or benefit from tested and appropriate security controls and privacy controls such as the General Data Protection Regulation (GDPR), e.g., it is understood that appropriate measures should be taken to help prevent misuse of computing systems through the injection or activation of malware in documents. Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types.

For instance, the descriptions of processes in connection with FIGS. 7 to 15 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

1. A computing system for credential-based anomaly detection in application identity accounts, comprising:
a digital memory configured to store sign-in data representing authentication attempts involving an application identity account, the application identity account being associated with a software application rather than a human user;
a processor operatively coupled to the digital memory, the processor configured to:
(a) collect sign-in data over a plurality of time intervals for the application identity account;
(b) extract a plurality of data features from the sign-in data; and
(c) for a credential used with the application identity account:
(i) aggregate the extracted data features across the plurality of time intervals to generate a credential-specific feature behavior log; and
(ii) construct a credential history profile characterizing temporal patterns of the data features associated with that credential; and
a machine learning model, trained on previously observed credential history profiles, configured to:
(a) receive as input a current credential history profile; and
(b) output an anomaly score indicating a likelihood that the credential is being used in a manner inconsistent with historical behavioral patterns; and
wherein the processor is further configured to take a security enforcement action based on the anomaly score.

2. The computing system of claim 1, wherein the plurality of data features comprises one or more of:
an IP subnet,
a credential type,
a hosted IP status,
a credential identifier,
a user agent, and
a resource access identifier.

3. The computing system of claim 1, wherein the security enforcement action comprises one of:
an increased amount of logging;
an alert to administrators or security personnel; or
a recommendation of replacement of a compromised credential.

4. The computing system of claim 1, further comprising a compromise assessment based upon the anomaly score, wherein the compromise assessment is used by an access control mechanism to perform the security enforcement action.

5. The computing system of claim 4, wherein the processor is further configured to formulate the compromise assessment at least in part by applying one or more heuristic rules to perform one or both of:
modify the anomaly score during computation of the compromise assessment; or
supersede the anomaly score during computation of the compromise assessment.

6. The computing system of claim 1, wherein one or both of the anomaly score or the compromise assessment are specific to the credential of the application identity account instead of to the application identity account.

7. The computing system of claim 1, wherein the processor is further configured to train the machine learning model using one or more of:
sign-in data that is specific to the application identity account;
sign-in data that is specific to a tenant that includes the application identity account;
sign-in data that is specific to a multi-tenant application program that includes the application identity account; or
sign-in data that has an age greater than a specified age, and not less than the specified age.

8. A computer-implemented method for detecting anomalies in application identity accounts being associated with a software application, comprising:
collecting, by a processor, sign-in data over a plurality of time intervals for the application identity account;
extracting, by the processor, a plurality of data features from the sign-in data;
for a credential used with the application identity account:
aggregating, by the processor, the extracted data features across the plurality of time intervals to generate a credential-specific feature behavior log; and
constructing, by the processor, a credential history profile characterizing temporal patterns of the data features associated with that credential;
receiving as input, by a machine learning model, a current credential history profile, wherein the machine learning model is trained on previously observed credential history profiles;
outputting, by the machine learning model, an anomaly score indicating a likelihood that the credential is being used in a manner inconsistent with historical behavioral patterns; and
performing, by the processor, a security enforcement action based on the anomaly score.

9. The method of claim 8, wherein the plurality of data features comprise one or more of:
an IP subnet,
a credential type,
a hosted IP status,
a credential identifier,
a user agent, and
a resource access identifier.

10. The method of claim 8, wherein security enforcement action comprises one or more of:
increasing the amount of logging;
alerting an administrator or security personnel; or
recommending replacement of a compromised credential.

11. The method of claim 8, further comprising a compromise assessment based upon the anomaly score, and the method further comprises:
utilizing the compromise assessment, by an access control mechanism, to perform the security enforcement actions.

12. The method of claim 11, wherein to formulate the compromise assessment, the method further comprises:
applying one or more heuristic rules, wherein applying the one or more heuristic rules results in one or both of:
modifying the anomaly score during computation of the compromise assessment; or
superseding the anomaly score during computation of the compromise assessment.

13. The method of claim 8, wherein one or both of the anomaly score and the compromise assessment are specific to the credential of the application identity account instead of to the application identity account.

14. The method of claim 8, further comprising:
training the machine learning model, using one or multiple of:
sign-in data that is specific to the application identity account;
sign-in data that is specific to a tenant that includes the application identity account;
sign-in data that is specific to a multi-tenant application program that includes the application identity account; or
sign-in data that has an age greater than a specified age, and not less than the specified age.

15. A non-transitory computer-readable medium stored thereon instructions to detect anomalies in application identity accounts associated with a software application that, in response to execution, cause a system comprising a processor to perform operations, the operations comprising:
collecting sign-in data over a plurality of time intervals for the application identity account;
extracting a plurality of data features from the sign-in data;
for a credential used with the application identity account:
aggregating the extracted data features across the plurality of time intervals to generate a credential-specific feature behavior log; and
constructing a credential history profile characterizing temporal patterns of the data features associated with that credential;
receiving as input, by a machine learning model, a current credential history profile, wherein the machine learning model is trained on previously observed credential history profiles;
outputting, by the machine learning model, an anomaly score indicating a likelihood that the credential is being used in a manner inconsistent with historical behavioral patterns; and
performing a security enforcement action based on the anomaly score.

16. The non-transitory computer-readable medium of claim 15, wherein the plurality of data features comprises one or more of:
an IP subnet;
a credential type;
a hosted IP status;
a credential identifier;
a user agent; or
a resource access identifier.

17. The non-transitory computer-readable medium of claim 15, wherein security enforcement action comprises one or more of:
increasing the amount of logging;
alerting an administrator or security personnel; or
recommending replacement of a compromised credential.

18. The non-transitory computer-readable medium of claim 15, further comprising a compromise assessment based upon the anomaly score, and the operations further comprises:
utilizing the compromise assessment, by an access control mechanism, to perform the security enforcement actions.

19. The non-transitory computer-readable medium of claim 18, wherein to formulate the compromise assessment, the operations further comprises:
applying one or more heuristic rules, wherein applying the one or more heuristic rules results in one or more of:
modifying the anomaly score during computation of the compromise assessment; or
superseding the anomaly score during computation of the compromise assessment.

20. The non-transitory computer-readable medium of claim 15, further comprising:
training the machine learning model, using one or more of:
sign-in data that is specific to the application identity account;
sign-in data that is specific to a tenant that includes the application identity account;
sign-in data that is specific to a multi-tenant application program that includes the application identity account; or
sign-in data that has an age greater than a specified age, and not less than the specified age.
